(19) United States
(12) Patent Application Publication
(10) Pub. No.: US 2025/0005696 A1
(43) Pub. Date: Jan. 2, 2025

(54) SCORE CALCULATING DEVICE AND SCORE CALCULATING METHOD

(71) Applicant: JVCKENWOOD Corporation, Yokohama-shi (JP)

(72) Inventors: Atsushi Saito, Yokohama-shi (JP); Shoji Ota, Yokohama-shi (JP); Masahito Arai, Yokohama-shi (JP); Hiroshi Takeshita, Yokohama-shi (JP); Atsushi Watanabe, Yokohama-shi (JP); Hiroyuki Matsuura, Yokohama-shi (JP)

(21) Appl. No.: 18/884,188

(22) Filed: Sep. 13, 2024

Related U.S. Application Data
(63) Continuation of application No. PCT/JP2022/042483, filed on Nov. 16, 2022.

(30) Foreign Application Priority Data
Mar. 15, 2022 (JP) 2022-040476

(51) Int. Cl. G06Q 50/22

(52) U.S. Cl. CPC G06Q 50/22

(57) ABSTRACT

A score calculating device includes: an isolation-score calculating unit configured to calculate, based on a history of position information of a plurality of subjects belonging to a predetermined group, an isolation score indicating a degree of isolation from a group for each of the subjects; a tendency-score calculating unit configured to calculate a tendency score indicating a tendency of each subject regarding interaction with others; and a communication-score calculating unit configured to calculate a communication score indicating a degree of communication with others in the group for each of the subjects during a target period based on the isolation score and the tendency score.

### CROSS-REFERENCE TO RELATED APPLICATIONS

This application is a Continuation of PCT International Application No. PCT/JP2022/042483 filed on Nov. 16, 2022 which claims the benefit of priority from Japanese Patent Application No. 2022-040476 filed on Mar. 15, 2022, the entire contents of both of which are incorporated herein by reference.

### BACKGROUND

The present disclosure relates to a score calculating device and a score calculating method.

In facilities such as schools, kindergartens, and nursery schools, there are concerns about issues such as bullying. In Japanese Laid-open Patent Publication Nos. 2021-096836, 2020-123204, and 2018112831, a detection system that uses video information, audio information, emotional information, and the like of a subject, to detect an issue such as bullying is described.

In the system described in Japanese Laid-open Patent Publication Nos. 2021-096836, 2020-123204, and 2018112831, distinguishing children that are experiencing an issue such as bullying and children that are participating in such an issue, detection of a post-incident event, such as injury, detection of a direct event, such as inappropriate word, and the like is performed. However, for issues such as bullying, it is preferable to be able to prevent it by taking a measure, such as intervening with the affected child and the surrounding children before the issue becomes apparent.

The present disclosure has been achieved in view of the above problems, and it is an object of the present disclosure to provide a score calculating device and a score calculating method that lead to prevention of issues among multiple subjects belonging to a group in advance.

### SUMMARY

A score calculating device according to the present disclosure includes: an isolation-score calculating unit configured to calculate, based on a history of position information of a plurality of subjects belonging to a predetermined group, an isolation score indicating a degree of isolation from a group for each of the subjects; a tendency-score calculating unit configured to calculate a tendency score indicating a tendency of each subject regarding interaction with others; and a communication-score calculating unit configured to calculate a communication score indicating a degree of communication with others in the group for each of the subjects during a target period based on the isolation score and the tendency score.

A score calculating method according to the present disclosure includes: calculating, based on a history of position information of a plurality of subjects belonging to a predetermined group, an isolation score indicating a degree of isolation from a group for each of the subjects; calculating a tendency score indicating a tendency of each subject regarding interaction with others; and calculating a communication score indicating a degree of communication with others in the group for each of the subjects during a target period based on the isolation score and the tendency score.

### BRIEF DESCRIPTION OF THE DRAWINGS

FIG. 1 is a functional block diagram illustrating an example of a score calculating device according to the present embodiment;

FIG. 2 is a diagram illustrating an example of a detection result of position information of a subject;

FIG. 3 is a diagram illustrating an example of a detection result of position information of a subject and an object; and

FIG. 4 is a flowchart illustrating a flow of operation of the score calculating device according to the present embodiment.

### DETAILED DESCRIPTION

Hereinafter, embodiments of a score calculating device and a score calculating method according to the present disclosure will be explained based on the drawings. The embodiments are not intended to limit this invention. Moreover, components in the following embodiments include those easily replaceable by a person skilled in the art, or those substantially same.

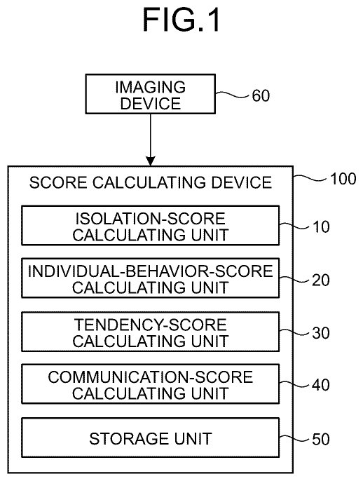

FIG. 1 is a functional block diagram illustrating an example of a score calculating device 100 according to the present embodiment. The score calculating device 100 illustrated in FIG. 1 calculates a communication score that indicates a degree of communication with others in a group for each subject, for multiple subjects belonging to a predetermined group. In the present embodiment, examples of the predetermined group include a school, a kindergarten, and a nursery school. Examples of the multiple subjects include students and the like belonging to these school, kindergarten, a nursery school, and the like.

The score calculating device 100 includes a processing device, such as a central processing unit (CPU), and a storage device, such as a random access memory (RAN) and a read only memory (ROM). As illustrated in FIG. 1, the score calculating device 100 includes an isolation-score calculating unit 10, an individual-behavior-score calculating unit 20, a tendency-score calculating unit 30, a communication-score calculating unit 40, and a storage unit 50.

The isolation-score calculating unit 10 calculates an isolation score based on a history of position information of multiple subjects belonging to a predetermined group. The isolation score is a score indicating the degree of isolation from a group of each subject. The isolation-score calculating unit 10 can calculate the isolation score, for example, based on an average value of distance between the target subject and other subjects during a target period, and an event count indicating the number of times the target subject being in proximity to other subjects for the duration of a first time period or more.

The isolation-score calculating unit 10 detects position information as coordinates for each subject. The position information is detected, for example, based on image data captured by an imaging device 60. The image data captured by the imaging device 60 can be stored in the storage unit 50. The imaging device 60 can be placed in a location in which the subject acts, such as a classroom of a school. In this case, the isolation-score calculating unit 10 can calculate position information, for example, as coordinates on a coordinate plane based on a predetermined position in the classroom.

The isolation-score calculating unit 10 distinguishes individual subjects to extract, for example, by image processing based on image data. The isolation-score calculating unit 10 calculates position information for each frame for the extracted individual subjects.

The isolation-score calculating unit 10 calculates an average value of distance between the target subject and other subjects in a predetermined period for each subject based on the calculated position information. For the predetermined period, a period such as a break time and time from arrival at school to departure from school can be set. The isolation-score calculating unit 10 can calculate, for example, a distance between the target subject and other subjects for each frame, and can calculate an average value by the number of frames.

The isolation-score calculating unit 10 calculates an average value (A), for example, as expressed by following equation. The following equation is focused on a single subject.

$$A = {Σ}_{0 to M - 2} {Σ}_{0 to N - 1} ( {Distance}_{m , n} ) / ( N \cdot ( M - 1 ) )$$

where Distance represents a distance between a target subject and other subjects in one frame. M represents the total number of people including the target subject and other subjects in a frame. m is a numerical value representing other subjects. The first person of the other subjects is represented by m=0. The last person of the other subjects is represented by m=M−2. n represents a frame number. The first frame is represented by n=0. Moreover, the final frame is represented by n=N−1.

The isolation-score calculating unit 10 detects, for each of the subjects, whether the target subject and another subject come into proximity to each other based on the calculated position information. When the target subject is in close proximity to another subject, it can be inferred that an event for communication, such as a conversation, has occurred between the target subject and another subject. Therefore, when it is detected that the target subject has come close to another subject, for each of the subjects, the isolation-score calculating unit 10 determines that an event has occurred between the target subject and another subject, and increments the event count by one.

The isolation-score calculating unit 10 can categorize each range, such as an individual distance (0.45 m or more and less than 1.2 m), and an intimate distance (0 m or more and smaller than 0.45 m), for example, based on the concept of personal space, and can set a different time period depending on the category as a first time period for detection of proximity. For example, the first time period corresponding to the individual distance can be set to 15 seconds, and the first time period corresponding to the intimate distance can be set to 5 seconds. In this case, the isolation-score calculating unit 10 detects the proximity when a distance between the target subject and another subject is the individual distance for 15 seconds or more, and when a distance between the target subject and another subject is in the proximity distance for 5 seconds or more, determines that an event has occurred, and increments the event count by one.

The isolation-score calculating unit 10 calculates the isolation score (S1) as expressed in the following equation based on the calculated average value (A) and the event count (B). The isolation-score calculating unit 10 stores the calculated isolation score (S1) in the storage unit 50.

$$S 1 = α \cdot A + ( 1 - α ) \cdot ( Max - B )$$

where α is a numeral representing a weight, and it can be set to 0≤α≤1. Moreover, Max represents the maximum value of the event count B. A value of the event count B is not incremented once it reaches Max.

The isolation score S1 indicates that the degree of isolation of the subject is higher as it becomes higher, and indicates that the degree of isolation of the subject is lower as it becomes lower. The isolation score S1 becomes higher as the average value of distance to another subject increases and as the event count decreases. Meanwhile, the isolation score S1 becomes lower as the average value of distance to another subject decreases, and as the event count increases.

The individual-behavior-score calculating unit 20 calculates the individual behavior score based on behavior information of a subject. The individual behavior score is a score that indicates a degree of actively engaging in individual behavior in a group. The behavior information of a subject to be the basis for calculating the individual behavior score is information on proximity to an object to engage in individual behavior, and when detecting that the target subject has come into proximity to the object to engage in individual behavior during a target period, the individual-behavior-score calculating unit 20 calculates the individual behavior score based on a type of the object for each detection. Examples of the object described above include a toy, a textbook, a notebook, a pencil, a book, and the like. When a target subject is in proximity to the object as described above, it can be estimated that the target subject is actively engaging in individual behavior using the object.

The individual-behavior-score calculating unit 20 can detect a type of the object and position information of the object by performing image processing and the like based on image data of the imaging device 60. The individual-behavior-score calculating unit 20 calculates a distance between the subject and the object based on the position information of the subject stored in the storage unit 50 and the calculated position information of the object.

The individual-behavior-score calculating unit 20 determines, for each subject, that the subject has engaged in individual behavior when it is detected that the subject and the object have come into proximity to each other. The individual-behavior-score calculating unit 20 can detect that the subject and the object are in close proximity to each other, for example, when the subject and the object are in the intimate distance (0 m or more and smaller than 0.45 m) described above, or when a state in which the subject and the object are in contact with each other has continued for the duration of a second time period or more.

When it is detected that the subject has been in close proximity to the object to engage in individual behavior for the duration of the second time period or more, the individual-behavior-score calculating unit 20 calculates the individual behavior score (S2) as expressed in a following equation based on the type of the object of each relevant detection. The individual-behavior-score calculating unit 20 stores the calculated individual behavior score S2 in the storage unit 50.

$$S2 = {Σ}_{0 to H - 1} ( {K}_{g , h} )$$

where K is a value indicating a weight for each detection, and g is a value indicating the type of an object. For example, it is possible to set the values corresponding to a toy A as g=1, K_{1,h}=10, the values corresponding to a toy B as g=2, K_{2,h}=8, the values corresponding to a textbook as g=3, K_{3,h}=5, and the like, and is possible to store setting results as information of a table or the like in the storage unit 50. h is a value indicating the number of times detection has been occurred, and H represents the total number of detections.

The higher individual behavior score S2 indicates the higher degree of the subject actively engaging in individual behavior, and the lower score indicates the lower degree of the subject actively engaging in individual behavior. The individual behavior score S2 is to be 0 when proximity to an object is not detected. Moreover, the individual behavior score S2 becomes higher when an object having a heavier weight is used.

The tendency-score calculating unit 30 calculates a tendency score. The tendency score is a score indicating a tendency of each subject regarding interaction with others. The tendency-score calculating unit 30 can calculate the tendency score based on a history of communication score of a subject and correction information set in advance for the subject.

The tendency-score calculating unit 30 calculates an average value of communication scores calculated in a past predetermined period (for example, past one year, or the like) for a subject as a typical value. In this case, the tendency-score calculating unit 30 can use the communication scores stored in the storage unit 50. The correction information may be a value evaluated by a teacher, a guardian, or the like of the subject for the extent to which the subject tends to engage in individual behavior. For the correction information, the value may be set, for example, based on a questionnaire or the like. When a subject is a new kindergarten student or the like and past communication scores of the subject is not stored in the storage unit 50, an average value of communication scores of typical children of the same age group may be used as the typical value.

The tendency-score calculating unit 30 calculates the tendency score (S3) as expressed in a following equation based on the typical value (C) and the correction information (D). The tendency-score calculating unit 30 stores the calculated tendency score S3 in the storage unit 50.

$$S 3 = C + D$$

The communication-score calculating unit 40 calculates the communication score based on the isolation score, the individual behavior score, and the tendency score. The communication score is a score indicating the degree of communication with others in a group of each subject.

The communication-score calculating unit 40 calculates the communication score (S4) as expressed in a following equation. The communication-score calculating unit 40 stores the calculated communication score S4 in the storage unit 50.

$$S 4 = β / S 1 + ( 1 - β ) \cdot S 2 \cdot S 3$$

where β represents a numeral indicating a weight, and may be set to 0≤β≤β≤1.

The communication score becomes higher value as the isolation score becomes lower and the individual behavior score and the tendency score become higher.

The storage unit 50 stores various kinds of information. The storage unit 50 includes a storage, such as a hard disk drive and a solid state drive. As the storage unit 50, an external storage medium, such as a removable disk, may be used. The storage unit 50 stores data and programs to perform processing in the isolation-score calculating unit 10, the individual-behavior-score calculating unit 20, the tendency-score calculating unit 30, and communication-score calculating unit 40 described above.

The storage unit 50 stores image data captured by the imaging device 60. The storage unit 50 stores calculation results of the isolation-score calculating unit 10. Examples of the calculation results of the isolation-score calculating unit 10 include the position information, the isolation score, and the like of each subject. The storage unit 50 stores calculation results of the individual-behavior-score calculating unit 20. Examples of the calculation results of the individual-behavior-score calculating unit 20 include the position information of each subject, the type and the position information of each object, the isolation behavior score, and the like. The storage unit 50 stores calculation results of the tendency-score calculating unit 30. Examples of the calculation results of the tendency-score calculating unit 30 include the typical value, the correction information, the tendency score of each subject, and the like. The storage unit 50 stores calculation results of the communication-score calculating unit 40. Examples of the calculation results of the communication-score calculating unit 40 include the communication score, and the like.

Next, a score calculating method according to the present embodiment will be explained. In the score calculating method according to the present embodiment, various locations, such as a classroom, a gymnasium, and a playground, are imaged using the imaging device 60 in facilities, such as a school, a kindergarten, and a nursery school, and supplies image data to the score calculating device 100.

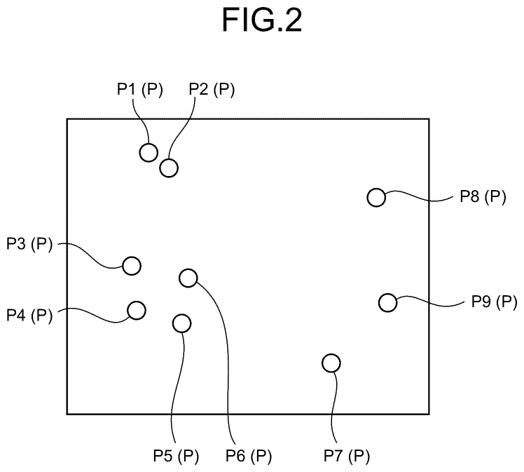

In the score calculating device 100, the isolation-score calculating unit 10 extracts multiple subjects, such as students, individually, and detects position information of each subject based on the supplied image data in each frame. FIG. 2 is a diagram illustrating an example of a detection result of the position information of subjects. FIG. 2 schematically illustrates an example of a detection result in a predetermined period. In the example illustrated in FIG. 2, the position information of multiple subjects P present in a classroom is illustrated. In the following, a case in which the state illustrated in FIG. 2 has continued for the duration of the first time period or more will be explained as an example. Moreover, when the multiple subjects P are distinguished from one another, the subjects P are denoted as subjects P1 to P9.

The isolation-score calculating unit 10 stores the detected position information of the respective subjects in the storage unit 50. The isolation-score calculating unit 10 is capable of storing the supplied captured image data not in video data in the storage unit 50 at this time. This prevents behavior of a subject from being excessively recorded, and prevents a subject that is a perpetrator of a trouble from unnecessarily standing out.

The isolation-score calculating unit 10 calculates an average value of distance between the target subject and other subjects based on the calculated position information. Moreover, the isolation-score calculating unit 10 detects whether the target subject and another subject have been in proximity for the duration of the first time period or more for each subject based on the calculated position information, and calculates the event count based on the detection result.

In the example illustrated in FIG. 2, the isolation-score calculating unit 10 calculates an average value of distance to another subject P, for each of subjects P1 to P9. Furthermore, the isolation-score calculating unit 10 detects that the subject P1 and the subject P2 have been in proximity to each other for the duration of the first time period or more. In this case, the event counts of the subject P1 and the subject P2 are incremented by one. Moreover, the isolation-score calculating unit 10 detects that the subjects P3, P4, P5, and P6 have been in proximity to one another for the duration of the first time period or more. In this case, the event counts of the subjects P3, P4, P5, and P6 are incremented by one. Furthermore, the isolation-score calculating unit 10 does not increment the event count for the subjects P7 to P9 because the subjects P7 to P9 are not in proximity to the other subjects P. The isolation-score calculating unit 10 calculates the isolation score based on the calculated average value and the event count. In the example illustrated in FIG. 2, the isolation scores of the subjects P7 to P9 become higher than the isolation scores of the subjects P1 to P6.

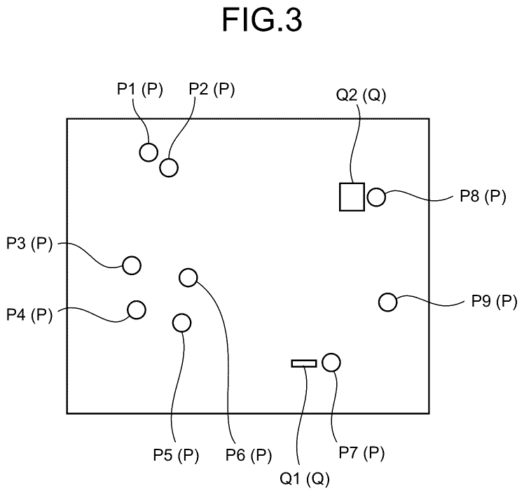

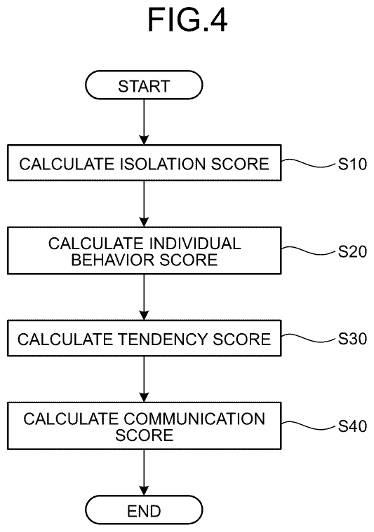

The individual-behavior-score calculating unit 20 extracts objects individually based on supplied image data, and detects position information of the objects. FIG. 3 is a diagram illustrating an example of a detection result of the position information of a subject and an object. FIG. 3 schematically illustrates an example of the detection result in a predetermined period. In the example illustrated in FIG. 3, the position information of the multiple subjects P present in a classroom and the position information of an object Q are indicated. In the following, a case in which the state illustrated in FIG. 4 has continued for the duration of the second time period or more will be explained as an example. Moreover, when distinguishing from one another, the multiple subjects P are denoted as the subjects P1 to P9, and when distinguishing the objects Q from one another, those are denoted as targets Q1, Q2.

The individual-behavior-score calculating unit 20 detects the object Q by image processing and the like. The individual-behavior-score calculating unit 20 detects a type and position information of the detected object Q. The individual-behavior-score calculating unit 20 detects, for each of the subjects P, whether the target subject P and the object Q have been in proximity for the duration of the second time period or more based on the position information of the object Q and the position information of the subject P detected by the isolation-score calculating unit 10. In the example illustrated in FIG. 3, the individual behavior scores of the subjects P7, P8 are higher than the isolation scores of the subjects P1 to P6, and P9.

In the example illustrated in in FIG. 3, the individual-behavior-score calculating unit 20 does not perform detection for the subjects P1 to P6, and P9 because those are not in proximity to the object. The individual-behavior-score calculating unit 20 detects that the subject P7 has been in proximity to the object Q1 for the duration of the second time period or more. The individual-behavior-score calculating unit 20 detects that the subject P8 has been in proximity to the object Q2 for the duration of the second time period or more. The individual-behavior-score calculating unit 20 calculates the individual behavior score based on the detection result.

The tendency-score calculating unit 30 calculates the typical value and the correction information for each subject, and calculates the tendency score based on the calculation result.

The communication-score calculating unit 40 calculates the communication score based on the calculated isolation score, the individual behavior score, and the tendency score respectively calculated. The communication score becomes higher as the isolation score becomes lower and the individual behavior score and the tendency score become higher.

For example, in the example illustrated in FIG. 2 and FIG. 3, because the subject P9 has a high isolation score and a low individual behavior score, the communication score is estimated to be low. On the other hand, the subject P9 tends to think alone, and it is possible to have a tendency of actively engaging in individual behavior even without an object. In such a case, the tendency score of the subject P9 is calculated high. Therefore, evaluation can be performed, distinguishing from a subject that cannot avoid passively engaging in individual behavior.

An administrator that manages multiple subjects can grasp the degree of communication of each subject with others in a group based on the calculated communication score. For example, by taking measures when there is a change in the communication score, such as a significant decrease in the communication score, it can lead to prevention of issues such as bullying.

FIG. 4 is a flowchart illustrating a flow of an operation of the score calculating device 100 according to the present embodiment. As illustrated in FIG. 4, in the score calculating device 100, the isolation-score calculating unit 10 calculates the isolation score for each subject based on a history of the position information of multiple subjects (step S10). At step S10, the isolation-score calculating unit 10 calculates the isolation score based on the average value of distance between the subject and another subject in a target period, and the event count indicating the number of times of the subject being in proximity to the other subject for the duration of the first time period or more during the target period.

Next, the individual-behavior-score calculating unit 20 calculates the individual behavior score indicating the degree of actively engaging in individual behavior in a group based on the behavior information of the subject (step S20). The individual-behavior-score calculating unit 20 calculates, when it is detected that the subject has been in proximity to the object for engaging in individual behavior for the duration of the second time period or more during the target period as the behavior information, the individual behavior score based on the type of the object of each relevant detection.

Next, the tendency-score calculating unit 30 calculates the tendency score indicating the tendency of each subject regarding interaction with others (step S30). At step S30, the tendency-score calculating unit 30 calculates the tendency score based on a history of the communication score of the subject, and the correction information set in advance for the subject.

Next, the communication-score calculating unit 40 calculates the communication score indicating the degree of communication with others in a group for each subject in a target period based on the isolation score, the individual behavior score, and the tendency score (step S40).

As described above, the score calculating device 100 according to the present embodiment includes the isolation-score calculating unit 10 that calculates the isolation score indicating the degree of isolation from a group for each subject, based on a history of the position information of multiple subjects belonging to a predetermined group, the individual-behavior-score calculating unit 20 that calculates the individual behavior score indicating the degree of actively engaging in individual behavior in a group based on the behavior information of the subject, the tendency-score calculating unit 30 that calculates the tendency score indicating the tendency of each subject regarding interaction with others, and the communication-score calculating unit 40 that calculates the communication score indicating the degree of communication of each subject with others in a group during a target period based on the isolation score, the individual behavior score, and the tendency score.

Moreover, the score calculating method according to the present embodiment includes calculating the isolation score that indicates the degree of isolation from a group for each subject based on a history of the position information of multiple subjects belonging to a predetermined group; calculating the individual behavior score that indicates a degree of actively engaging in individual behavior in a group based on the behavior information of the subject; calculating the tendency score that indicates a tendency of each subject regarding interaction with others; and calculating the communication score that indicates a degree of communication with others in a group for each subject based on the isolation score, the individual behavior score, and the tendency score.

According to this configuration, the communication score of each subject can be calculated for multiple subjects belonging to a predetermined group. Therefore, by using the calculated communication score, for example, measures can be taken before a post-event phenomenon, a direct event, and the like are detected. This enables to prevent issues among multiple subjects belonging to a group in advance. Moreover, by using the individual behavior score and the tendency score in calculation of the communication score, the tendency of each subject is considered, for example, whether being alone is an active choice, whether it is preferred to be alone, or the like. Therefore, the communication score tailored to a subject can be calculated.

In the score calculating device 100 according to the present embodiment, the isolation-score calculating unit 10 calculates the isolation score based on the average value of distance between a subject and another subject during a target period, and the event count indicating the number of times the subject and other subjects come into proximity to each other during the target period. According to this configuration, the isolation score of a subject can be calculated highly accurately.

In the score calculating device 100 according to the present embodiment, the individual-behavior-score calculating unit 20 calculates, when it is detected that a subject has been in proximity to an object for engaging in individual behavior during a target period as the behavior information, the individual behavior score based on the type of the object of each relevant detection. According to this configuration, the individual behavior score of a subject can be calculated highly accurately.

In the score calculating device 100 according to the present embodiment, the tendency-score calculating unit 30 calculates the tendency score based on a history of the communication score of a subject and the correction information set in advance for the subject. According to this configuration, the tendency score of a subject can be calculated highly accurately.

The technical scope of the present disclosure is not limited to the embodiments described above, and modifications can be made as appropriate without departing from the gist of the present disclosure. For example, in the above embodiments, a configuration in which position information of a subject is detected based on image data of the imaging device 60 has been explained as an example, but it is not limited thereto. For example, it may be configured to detect position information of a subject using other means, such as an infrared sensor and a GPS.

According to the present disclosure, it becomes possible to lead to prevention of issues among multiple subjects belonging to a group in advance.

The score calculating device and the score calculating method according to the present disclosure can be applied to a processing device such as a computer.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A score calculating device comprising:
an isolation-score calculating unit configured to calculate, based on a history of position information of a plurality of subjects belonging to a predetermined group, an isolation score indicating a degree of isolation from a group for each of the subjects;
a tendency-score calculating unit configured to calculate a tendency score indicating a tendency of each subject regarding interaction with others; and
a communication-score calculating unit configured to calculate a communication score indicating a degree of communication with others in the group for each of the subjects during a target period based on the isolation score and the tendency score.

2. The score calculating device according to claim 1, wherein
the isolation-score calculating unit is configured to calculate the isolation score based on an average value of distance between the subject and another of the subjects during the target period, and on an event count indicating number of times the subject comes in proximity to another of the subjects during the target period.

3. The score calculating device according to claim 1, wherein
the tendency-score calculating unit is configured to calculate the tendency score based on a history of the communication score for the subject and based on correction information set in advance for the subject.

4. The score calculating device according to claim 1, further comprising an individual-behavior-score calculating unit configured to calculate, when it is detected that the subject has come into proximity to an object for engaging in individual behavior during the target period, an independent behavior score indicating a degree of actively engaging in individual behavior in the group based on a type of the object for each relevant detection,
wherein the communication-score calculating unit is configured to calculate a communication score indicating a degree of communication with others in the group for each of the subjects during a target period based on the isolation score, the independent behavior score, and the tendency score.

5. A score calculating method comprising:
calculating, based on a history of position information of a plurality of subjects belonging to a predetermined group, an isolation score indicating a degree of isolation from a group for each of the subjects;
calculating a tendency score indicating a tendency of each subject regarding interaction with others; and
calculating a communication score indicating a degree of communication with others in the group for each of the subjects during a target period based on the isolation score and the tendency score.
